(19) United States
(12) Patent Application Publication
(10) Pub. No.: US 2020/0406933 A1
(43) Pub. Date: Dec. 31, 2020

(54) AUTOMATIC DRIVING VEHICLE AND OPERATION MANAGEMENT SYSTEM

(71) Applicant: TOYOTA JIDOSHA KABUSHIKI KAISHA, Toyota-shi (JP)

(72) Inventors: Hirohito IDE, Nagoya-shi (JP); Yuchi YAMANOUCHI, Toyota-shi (JP); Kazuhiro UMEDA, Nissin-shi (JP)

(73) Assignee: TOYOTA JIDOSHA KABUSHIKI KAISHA, Toyota-shi (JP)

(21) Appl. No.: 16/913,347

(22) Filed: Jun. 26, 2020

(30) Foreign Application Priority Data
Jun. 28, 2019 (JP) 2019-121401

(51) Int. Cl. B60W 60/00

(52) U.S. Cl. CPC B60W 60/0054; B60W 60/0055; B60W 60/00253; B60W 60/0021; B60W 60/0061

(57) ABSTRACT

An automatic driving vehicle has an automatic mode to automatically operate along a predetermined travel route in accordance with an operation schedule provided from an operation management center through communication and so as to arrive at a predetermined spot at predetermined time. In a case where the communication is normal, the automatic driving vehicle operates automatically in accordance with the operation schedule provided in the automatic mode through the communication, and in a case where abnormality occurs in the communication, the automatic mode shifts to a semiautomatic mode to operate the automatic driving vehicle in a state where a function of communicating with the operation management center is limited.

### CROSS REFERENCE TO RELATED APPLICATION

The entire disclosure of Japanese Patent Application No. 2019-121401 filed on Jun. 28, 2019, including the specification, claims, drawings, and abstract, is incorporated herein by reference in its entirety.

### TECHNICAL FIELD

The present disclosure relates to an automatic driving vehicle that automatically travels along a travel route predetermined in accordance with an operation schedule and an operation management system that manages an operation of the vehicle.

### BACKGROUND

Heretofore, there have been various suggestions as to automatic driving of a vehicle. In JP 2002-053044 A (Patent Literatures 1), there is disclosed a system in which an automatic driving vehicle automatically travels along a predetermined course while stopping at respective stations. In this system, a traffic control center controls arrival and departure of the automatic traveling vehicle at each station based on a standard timetable. In particular, departure time and scheduled arrival time at the next station are transmitted to the automatic traveling vehicle to determine a travel pattern between the stations, so that a vehicle operation can be managed without changing the standard timetable. Furthermore, in JP 2017-182137 A (Patent Literatures 2), there is disclosed a system to control operation of a bus in response to a user's request. That is, an operation management center prepares an operation plan indicating when and where the bus travels in response to the user's request, and this plan is transmitted to the bus, so that the bus travels based on the operation plan.

According to systems described in Patent Literatures 1 and 2, in a center, it is determined when and where an automatic driving vehicle travels, to control automatic driving of the vehicle. Therefore, it is assumed that communication is normally performed in the automatic driving vehicle. Furthermore, in Patent Literatures 1 and 2, it is not examined how to operate the automatic driving vehicle if a communication abnormality occurs in the vehicle. Additionally, it is not efficient to prepare a preliminary vehicle just in a case where the communication abnormality occurs.

It is an advantage of the present disclosure to continue an operation by use of an automatic operating function also in a case where communication abnormality occurs in an automatic driving vehicle.

### SUMMARY

According to the present disclosure, provided is an automatic driving vehicle having an automatic mode to automatically operate along a predetermined travel route in accordance with an operation schedule provided from an operation management center through communication, and so as to arrive at a predetermined spot at a predetermined time, wherein in a case where the communication is normal, the vehicle automatically operates in accordance with the operation schedule provided in the automatic mode through the communication, and in a case where abnormality occurs in the communication, the automatic mode shifts to a semiautomatic mode to operate the automatic driving vehicle in a state where a function of communicating with the operation management center is limited.

Furthermore, the operation schedule may include information on arrival time at a predetermined location in the travel route, and in the semiautomatic mode, the vehicle may autonomously travel along the travel route without following the operation schedule after the occurrence of the abnormality.

Additionally, in the semiautomatic mode, a function of automatically steering, autonomously traveling along the predetermined travel route, and automatically accelerating may be limited, and at least part of the automatic acceleration in the automatic mode may be performed depending on occupant's manipulation.

Furthermore, in the semiautomatic mode, acceleration and deceleration may be performed depending on the occupant's manipulation.

Additionally, in a case where the communication returns to normal, the mode may shift to the automatic mode that follows the operation schedule after the communication is restored.

Furthermore, according to the present disclosure, provided is an operation management system that provides a plurality of automatic driving vehicles with an operation schedule in which it is that the vehicles will arrive at a predetermined spot at a predetermined time through communication from an operation management center, and automatically operates the automatic driving vehicles in a predetermined travel route, wherein in a case where the communication is normal, the respective automatic driving vehicles are provided with the operation schedule, and are automatically operated in an automatic mode to automatically operate the respective automatic driving vehicles in accordance with the operation schedule, and in a case where abnormality occurs in the communication with some of the automatic driving vehicles, the automatic driving vehicles having the normal communication continues to be operated in the automatic mode as they are, and the automatic driving vehicles having the abnormality occurring in the communication autonomously travel in a semiautomatic mode to operate the automatic driving vehicles in a state where a function of communicating with the operation management center in the automatic mode is limited.

Additionally, according to the present disclosure, provided is an automatic driving vehicle that travels along a predetermined travel route, and has an automatic mode to automatically accelerate, decelerate and steer in accordance with an operation schedule provided through communication from an operation management center, and so as to arrive at a predetermined spot at a predetermined time, a semiautomatic mode to automatically steer, and to accelerate and decelerate, depending on occupant's manipulation in a state where a function of communicating with the operation management center in the automatic mode is limited, and a manual mode to accelerate, decelerate and steer depending on the occupant's manipulation.

Furthermore, the automatic driving vehicle may include a mechanical manipulating part to be manipulated by the occupant, and may steer, accelerate and decelerate in accordance with a front, rear, right or left direction of a force applied to the mechanical manipulating part by the occupant.

According to the present disclosure, in a case where communication failure occurs in an automatic driving vehicle, an operation of the automatic driving vehicle by use of the automatic operating function can be continued, while an automatic operating function is partially limited by a semiautomatic mode. Consequently, the vehicle is not immediately removed from operation, and work of an occupant who performs the manipulation is relatively facilitated.

### BRIEF DESCRIPTION OF DRAWINGS

An embodiment of the present disclosure will be described based on the following figures, wherein:

FIG. 1 is a block diagram showing an entire configuration of a vehicle operation system that operates an automatic driving vehicle;

FIG. 2 is a block diagram showing a configuration of a vehicle 10 that automatically drives;

FIG. 3 is a diagram schematically showing an example of a travel route of the vehicle 10;

FIG. 4 is a flowchart showing processing during normal travel;

FIG. 5 is a flowchart to stop and start the vehicle at a stopping place;

FIG. 6 is a schematic view around a stopping place 52;

FIG. 7 is a front view of a configuration example of a mechanical manipulating part 36c; and

FIG. 8 is a side view of the configuration example of the mechanical manipulating part 36c.

### DESCRIPTION OF EMBODIMENT

Hereinafter, an embodiment of the present disclosure will be described with reference to the drawings. Note that the present disclosure is not limited to the embodiment described herein.

### [Vehicle Operation System Entire Configuration]

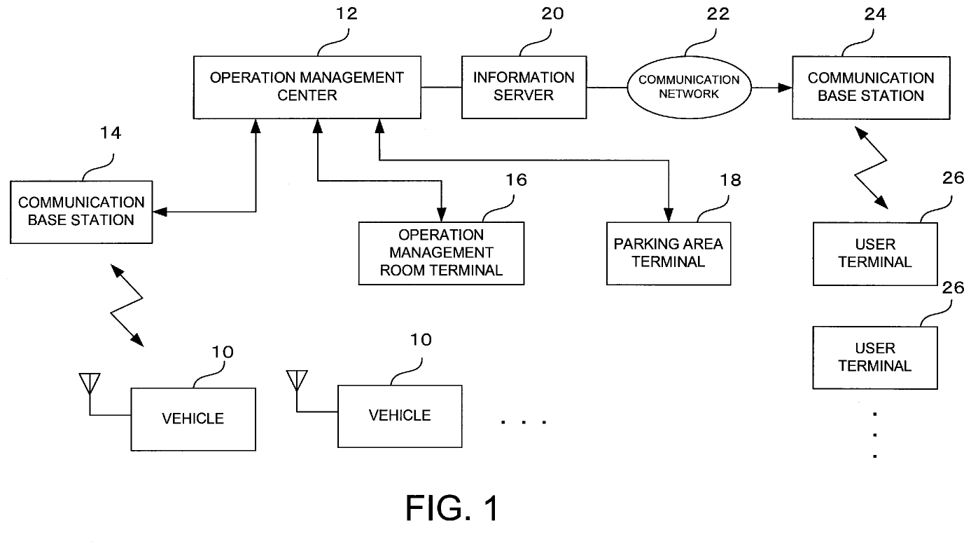

FIG. 1 is a block diagram showing an overall configuration of a vehicle operation system that operates an automatic driving vehicle. In this system, a plurality of automatic driving vehicles (vehicles) 10 operate along a predetermined travel route. Each of the vehicles 10 is, for example, a passenger bus to be operated on a determined route, and makes rounds of certain areas while stopping at stopping places such as bus stops.

An operation management center 12 includes a computer having a communicating function, and manages operation of the vehicles 10. That is, an operation plan of a plurality of vehicles 10 that includes putting into service (going into the determined rout) and removing from service (going out from the determined rout) of the vehicles 10 is prepared and stored. This operation plan includes an operation schedule indicating when and where the respective vehicles 10 travel (e.g., estimated (scheduled) time to arrive at a predetermined location). For example, the respective vehicles 10 will arrive at the predetermined location every 15 minutes if the vehicles travel at 20 km/h and distance between two vehicles 10 is 5 km. The operation management center 12 always grasps the location of each of the vehicles 10, and updates the operation schedule of each vehicle 10 to transmit the schedule to the corresponding vehicle 10 as needed. Each vehicle 10 controls travel (acceleration and deceleration) to arrive at the predetermined location at the estimated arrival time in accordance with the transmitted operation schedule. Thus, the operation schedule transmitted from the operation management center 12 to the vehicle 10 includes at least a command for travel speed, including the estimated arrival time for the vehicle 10 to arrive at the predetermined location. Furthermore, the operation management center 12 can automatically prepare a corresponding plan in case of emergency, such as failure of the vehicle 10.

The operation management center 12 is connected to a plurality of communication base stations 14, and the plurality of communication base stations 14 are connected to the plurality of vehicles 10 via wireless communication. Therefore, the vehicle 10 can travel in accordance with the command from the operation management center 12 while exchanging information with the operation management center 12 through the communication.

The operation management center 12 is connected to an operation management room terminal 16, and the operation management room terminal 16 accepts inputs of the necessary command or data in the operation management center 12, and provides a system operator with information by use of a display or the like.

The operation management center 12 is connected to a parking area terminal 18. The parking area terminal 18 is provided in a parking area where the offline vehicle 10 that does not automatically travel is parked, and through the terminal, necessary information associated with the parking area is input and output. In the parking area, a charging facility is provided, and a battery to be mounted in the vehicle 10 can be charged if necessary.

The operation management center 12 is connected to an information server 20. The information server 20 provides a user with operation information of the vehicle 10. The information server 20 is connected to a communication base station 24 via a communication network 22, and the communication base station 24 is connected to user terminals 26 via wireless communication. Each of the user terminals 26 may be a portable terminal such as a smartphone, and the user who gets in the vehicle 10 checks an operating situation of the vehicle 10. Note that a terminal is also provided at each stopping place, and information on the vehicle 10 that arrives at the stopping place next is displayed.

[Configuration of Vehicle]

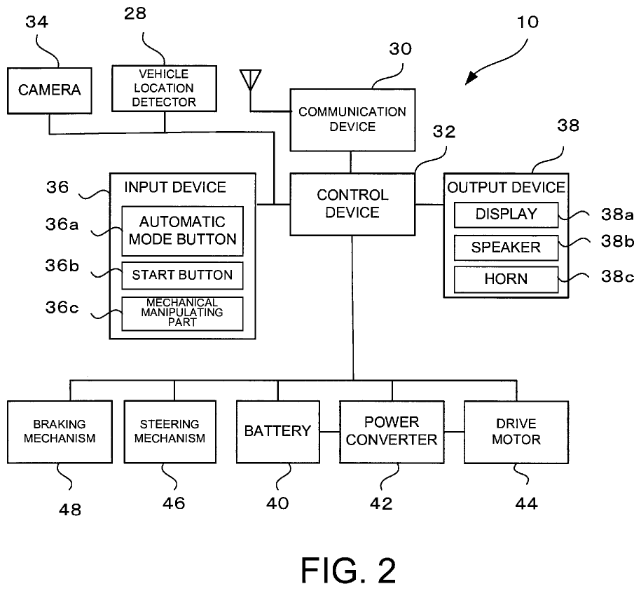

FIG. 2 is a block diagram showing a configuration of the vehicle 10 that has an automatic mode to automatically drive in accordance with an instruction from the operation management center 12, and that automatically drives. A communication device 30 wirelessly communicates with the communication base station 14, to transmit and receive various types of information. The communication device 30 is connected to a control device 32, and the information to be transmitted and received in the communication device 30 is processed by the control device 32. The control device 32 controls overall operation, including the travel of the vehicle 10.

The control device 32 is connected to a vehicle location detector 28, a camera 34, and an input device 36 that accepts input of data, and a vehicle location (present location) detected by the vehicle location detector 28, an image around the vehicle 10 that is captured in the camera 34, a travel command that is input from the input device 36 and the like are supplied to the control device 32. The vehicle location detector 28 includes a GPS device or the like and a gyroscope, and detects vehicle location information as needed, also by use of location information from beacons along the travel route, a transmitter of the stopping place or the like. The detected vehicle location, the captured peripheral image and others are appropriately supplied to the operation management center 12. The input device 36 includes an automatic mode button 36a for shifting to the automatic mode, a start button 36b to command start of the vehicle 10 at the stopping place or the like, and a mechanical manipulating part 36c to be manipulated by the operator. Furthermore, the control device 32 is connected to an output device 38 including a display 38a, a speaker 38b, and a horn 38c, from which necessary information is output.

Furthermore, in the vehicle 10, a battery 40, a power converter (for example, inverter) 42 and a drive motor 44 are mounted, and DC power from the battery 40 is converted to desired AC power by the power converter 42 and supplied to the drive motor 44. Consequently, the drive motor 44 is driven, and wheels are rotated by output of the motor, so that the vehicle 10 travels. Furthermore, a steering mechanism 46 controls steering of the vehicle 10. Additionally, a braking mechanism 48 controls deceleration and stopping of the vehicle. The power converter 42, the steering mechanism 46 and the braking mechanism 48 are connected to the control device 32, and the control device 32 controls travel of the vehicle 10. Note that the power converter 42 is controlled, to perform regenerative braking of the drive motor 44. Note that the control device stores information on the travel route, and enables autonomous travel based on the vehicle location, camera information or the like.

### [Travel Route]

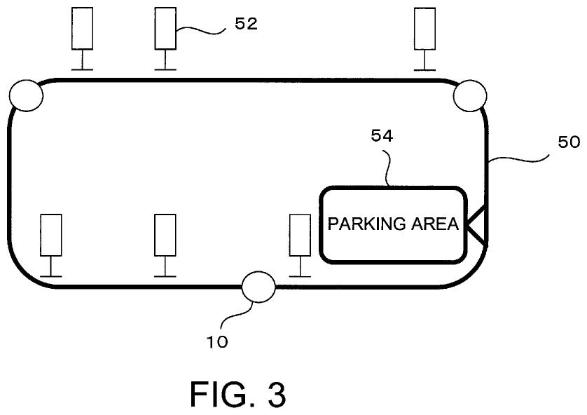

FIG. 3 is a diagram schematically showing an example of the travel route of the vehicle 10. In this example, a travel route 50 is a circuit route, and three vehicles 10 operate via an almost equal distances apart. Stopping places 52 are installed at appropriate intervals in accordance with uses of passengers. For example, one of the stopping places 52 is a transfer stopping place to a separate bus stop or a train station, or another stopping place is close to certain passenger's home. Furthermore, one place (an entrance passage and an exit passage) of the travel route 50 is connected to a parking area 54, and the vehicle 10 is put into service from the parking area 54 to the travel route 50 or removed (bounced) from the travel route 50 to the parking area 54.

Note that FIG. 3 schematically shows the travel route 50, and an actual travel route 50 is not such a simple route, and includes, for example, an intersection or a turning point. Furthermore, turning (turnaround) travel at a predetermined turning point may be autonomously performed. A turning program that defines how to turn at the predetermined turning place is stored in the control device 32, and the turning travel is performed by executing the turning program.

### [Operation Control]

The operation of the plurality of vehicles 10 are basically managed by the operation management center 12. Consequently, for a vehicle 10 that is operable, vehicle information is stored together with an identification number of the vehicle in the operation management center 12. Furthermore, in the operation management center 12, the operation plan drafted using the operation management room terminal 16 or the like in advance is stored. That is, for example, putting a predetermined number of vehicles 10 into service on the travel route 50 one by one to start the operation is scheduled, and in a case where a vehicle 10 requires charging, removing the vehicle 10 from the service and putting a vehicle 10 on standby into the service is scheduled.

Furthermore, in the operation, the vehicles 10 are controlled to travel basically with equal distance apart. That is, each of the vehicles 10 provides the operation management center 12 with the information on the vehicle location as needed, and the operation management center 12 updates individual operation schedules so that the time difference between one vehicle to the next vehicle is always same at each stopping place, as needed, and transmits each of the schedules to each vehicle 10. Then, a vehicle speed (acceleration and deceleration) and the like of the vehicle 10 are controlled in accordance with the operation schedule sent from the operation management center 12. Furthermore, the number of the vehicles 10 to be operated is determined by the operation management center 12, and the vehicle 10 is automatically put in service or removed from the service in accordance with the instruction from the operation management center 12. Note that information on a battery residual capacity is also periodically supplied from the vehicle 10 to the operation management center 12, and a vehicle 10 having a battery residual capacity below a set value is automatically replaced with the charged vehicle 10.

### [Automatic Mode]

The operation management center 12 transmits the predetermined operation schedule of each vehicle 10 to control its traveling. The operation management center 12 always grasps the location of each vehicle 10 to update the operation schedule as needed, the operation schedule includes an instruction for acceleration and deceleration (the travel speed of the vehicle 10) so that each vehicle 10 basically arrives at each stopping place at same intervals. Note that the operation management center 12 provides the vehicle 10 with information on a location of the other vehicle 10, so that an operator of the vehicle 10 can know the operating situation of the other vehicle and provide the user with the information. Here, the operator of the vehicle 10 has to be an occupant who manipulates the vehicle 10, and the operator may be an occupant intended for vehicle manipulation, or a passenger who gets on the vehicle to reach a destination. Note that in this example, the steering is autonomously controlled in the automatic mode.

When approaching the stopping place, vehicle stop control is entered at a predetermined location, to stop at the stopping place. After the stop, doors automatically open, and the occupants get on and off. When the vehicle definitely stops at all the stopping places, it is not necessary to take into consideration a stop request or the like from the occupant, but the vehicle may stop in response to the stop request.

After the vehicle stops, the vehicle releases the stop depending on operator's start manipulation, and enters start control to start. At this point, the vehicle 10 autonomously stops and starts at the stopping place. Afterward, the vehicle automatically travels in response to the instruction from the operation management center 12.

### [Processing During Communication Abnormality]

As described above, the automatic travel of the vehicle in the travel route 50 is basically controlled by the operation management center 12. On the other hand, the operation management center 12 is connected to the vehicle via wireless communication, and communication abnormality may occur. In such a case, it is considered that the automatic travel of the vehicle 10 is stopped, the operation of the vehicle 10 is stopped, or the driving is switched to manual driving by the operator. However, such measures may not be preferable for the passenger and the operator.

In the present embodiment, in a case of communication abnormality, the vehicle drives in the semiautomatic mode. That is, even in a state where there are not any instructions through the communication from the operation management center 12, the vehicle autonomously travels along the travel route in the semiautomatic mode as long as a function is prepared for the automatic travel. The semiautomatic mode is a mode in which the instruction is not received through the communication from the operation management center 12, and a function of the operation in the automatic mode is partially limited.

### <Semiautomatic Mode>

The vehicle 10 stores the information on the travel route in advance. Furthermore, the vehicle location information is acquired as needed in accordance with the location information from the vehicle location detector 28. Additionally, the vehicle has an autonomous travel function at the stopping place, the turning point or the like. Since the vehicle has such an autonomous travel function, it can autonomously travel along the travel route without manipulation by the operator. On the other hand, it is considered that in the vehicle 10, the operation schedule from the operation management center 12 cannot be obtained, and hence accuracy of the control of the operation decreases.

To solve this problem, the vehicle 10 travels in the semiautomatic mode, not in the automatic mode. This semiautomatic mode is a limited automatic mode in which at least some automatic operating functions are limited.

As described above, in a normal automatic mode, the vehicle 10 is provided with the operation schedule including the arrival time at the predetermined location on the travel route, that is, information on when and where the vehicle 10 travels, as needed. In the semiautomatic mode, the vehicle does not receive such information and autonomously travels based on the prestored travel route information or the like. That is, steering is automatically controlled without external information, in other words, the vehicle 10 travels autonomously. Furthermore, in a case where an obstacle is found, the vehicle automatically performs emergency stopping as usual, for example. Note that after the occurrence of the communication abnormality, the operation schedule may not be received as described above, a schedule that was already received may be ignored.

Furthermore, in the semiautomatic mode, the vehicle accelerates during the travel, depending on an operator's manipulation. That is, in the semiautomatic mode, the vehicle accelerates and decelerates depending on the operator's manipulation, but may automatically decelerate.

Therefore, also when starting, the vehicle does not start if the operator does not input any acceleration request. Furthermore, during travel after the start, the vehicle does not accelerate if the operator does not input any acceleration request.

Therefore, when approaching the intersection, the vehicle automatically decelerates, passes the intersection at a predetermined speed, and accelerates in response to the operator's acceleration request after having passed the intersection. Furthermore, when approaching the stopping place, the vehicle automatically executes a vehicle stop sequence at the stopping place, to stop at the stopping place. Furthermore, the vehicle starts from the stopping place and accelerates depending on the operator's manipulation.

Here, the vehicle may automatically accelerate up to the predetermined speed at the start, that is, may automatically execute a start sequence. For example, in response to depression of the start button 36b by the operator, the vehicle may execute the start sequence, and automatically accelerate up to the predetermined speed (e.g., 10 km/h), and further accelerate in response to the operator's acceleration request.

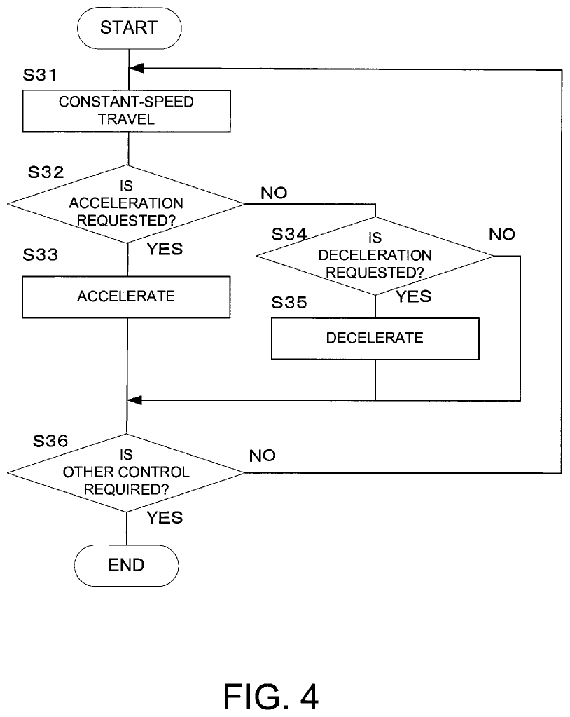

FIG. 4 is a flowchart showing processing during normal travel in the semiautomatic mode. First, the vehicle travels constantly at a presently set speed (S31). It is determined whether there is the acceleration request by the operator (S32), and if YES, the vehicle accelerates in response to operator's input (S33). If NO in the determination of S32, it is determined whether there is operator's deceleration request or deceleration request in the autonomous travel (S34), and if YES, the vehicle decelerates in response to the deceleration request (S35).

In a case where the acceleration of S33 or the deceleration of S35 ends and in a case where no acceleration or deceleration request is present, it is determined whether other control at the intersection, the stopping place, or the like is required (S36), and if NO, the processing returns to S31. If YES in the determination of S36, the normal travel ends, and control shifts to another control. Thus, the acceleration is performed depending on the operator's manipulation.

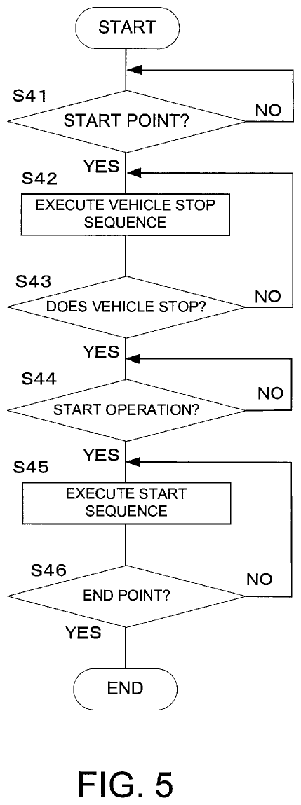

FIG. 5 is a flowchart of stopping and starting the vehicle at the stopping place in the semiautomatic mode. In this example, the vehicle also automatically accelerates to reach the predetermined speed.

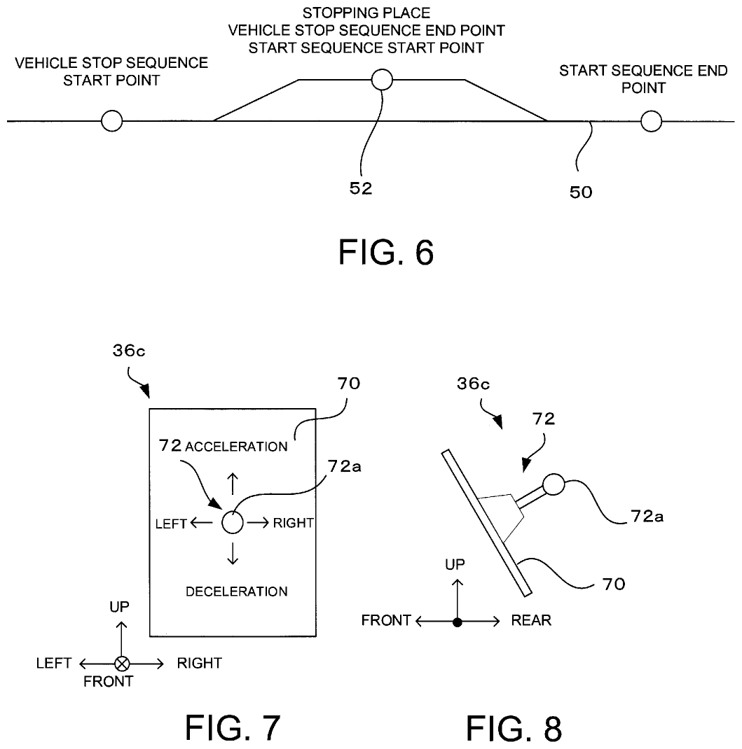

Here, FIG. 6 is a schematic view around the stopping place 52. Thus, a vehicle stop sequence start point to stop the vehicle at the stopping place 52 is set at a predetermined distance before the stopping place 52, and a start sequence end point to start from the stopping place 52 is set at a predetermined distance from the stopping place 52. The stopping place 52 is a vehicle stop sequence end point and a start sequence start point.

In the figure, it is first determined whether the vehicle reaches the vehicle stop sequence start position at the predetermined distance before the stopping place (S41). If YES in S41, the vehicle executes the vehicle stop sequence (S42). Consequently, the vehicle 10 stops at the stopping place. Then, it is determined whether the vehicle stops (S43), and when the vehicle stops, it is determined whether a start manipulation is performed (e.g., the start button 36b is depressed) (S44). If YES in the determination of S44, the start sequence is executed (S45), for starting. Then, it is determined whether the vehicle reaches the start sequence end position (S46), and in a case where the end position is reached, the start sequence ends, and stop and start control at the stopping place is ended.

Note that in a case where the acceleration is performed depending on the operator's manipulation, the start sequence is executed depending on the operator's manipulation. Furthermore, also in a case where the vehicle stops or decelerates at the intersection, similar processing may be performed.

Then, in a case where the battery residual capacity is a predetermined value or less, a removing sequence is executed in autonomous travel, and the vehicle may automatically enter the parking area 54. Note that in a case where the communication abnormality occurs, the vehicle may automatically enter the parking area 54 when first approaching the parking area 54.

Note that in the semiautomatic mode, the operation schedule received before the occurrence of the communication abnormality is basically ignored and accelerate and decelerate in accordance with operator's judgment, but after the occurrence of the communication abnormality, the vehicle may automatically travel in accordance with the operation schedule before the occurrence of the abnormality.

Furthermore, in a case where the communication returns to normal, the vehicle may shift to the automatic mode that follows the operation schedule after the communication is restored.

Additionally, in a case where abnormality occurs in the communication of all the vehicles 10, all the vehicles 10 may shift to a semiautomatic operation mode and continue the operation.

FIG. 7 is a front view of a configuration example of the mechanical manipulating part 36c, and FIG. 8 is a schematic side view of the configuration example of the mechanical manipulating part 36c.

Thus, the mechanical manipulating part 36c includes a lever 72 that protrudes from a front panel 70 and can be tilted upward, downward, rightward and leftward, and a tip 72a of the lever 72 is manipulated by the operator's hand to generate a manipulation signal. The manipulation signal is supplied to the control device 32, and the control device 32 controls the travel of the vehicle 10 in response to the manipulation signal.

In this example, the front panel 70 of the mechanical manipulating part 36c is disposed on a front wall in a vehicle interior (below a front window), and the operator can manipulate the mechanical manipulating part 36c while looking forward. Furthermore, as shown in FIG. 8, the front panel 70 extends diagonally upward and forward. Additionally, a steering direction is displayed in a right-left direction, and acceleration and deceleration are displayed in an up-down direction.

### <Manual Mode>

The vehicle 10 also has a manual mode. In this manual mode, unlike the automatic mode or the semiautomatic mode, the vehicle does not automatically travel, and steers, accelerates and decelerates depending on the operator's manipulation. Note that upper limit speeds (e.g., 20 km/h or the like) in the automatic mode, the semiautomatic mode and the manual mode may be the same, and may be separately set. Note that the deceleration by the mechanical manipulating part 36c may be performed appropriately using both the regenerative braking of the drive motor 44 and a mechanical brake. Furthermore, a mechanical or electrical parking brake may be separately provided.

1. An automatic driving vehicle having an automatic mode to automatically operate along a predetermined travel route in accordance with an operation schedule provided from an operation management center through communication and so as to arrive at a predetermined spot at predetermined time, wherein
in a case where the communication is normal, the vehicle automatically operates in accordance with the operation schedule provided in the automatic mode through the communication, and
in a case where abnormality occurs in the communication, the automatic mode shifts to a semiautomatic mode to operate the automatic driving vehicle in a state where a function of communicating with the operation management center is limited.

2. The automatic driving vehicle according to claim 1, wherein
the operation schedule includes information on arrival time at a predetermined location on the travel route, and
in the semiautomatic mode, the vehicle autonomously travels along the travel route without following the operation schedule after the occurrence of the abnormality.

3. The automatic driving vehicle according to claim 1, wherein in the semiautomatic mode, a function of automatically steering, autonomously traveling along the predetermined travel route and automatically accelerating is limited, and at least part of the automatic acceleration in the automatic mode is performed depending on occupant's manipulation.

4. The automatic driving vehicle according to claim 3, wherein in the semiautomatic mode, acceleration and deceleration are performed depending on the occupant's manipulation.

5. The automatic driving vehicle according to claim 1, wherein in a case where the communication returns to normal, the mode shifts to the automatic mode that follows the operation schedule after the communication is restored.

6. An operation management system that provides a plurality of automatic driving vehicles with an operation schedule in which it is determined that the vehicles will arrive at a predetermined spot at a predetermined time through communication from an operation management center, and automatically operates the automatic driving vehicles on a predetermined travel route, wherein
in a case where the communication is normal, the respective automatic driving vehicles are provided with the operation schedule, and are automatically operated in an automatic mode to automatically operate the respective automatic driving vehicles in accordance with the operation schedule, and
in a case where abnormality occurs in the communication with some of the automatic driving vehicles, the automatic driving vehicles having the normal communication continue to be operated in the automatic mode as they are, and the automatic driving vehicles having the abnormality occurring in the communication autonomously travel in a semiautomatic mode to operate the automatic driving vehicles in a state where a function of communicating with the operation management center in the automatic mode is limited.

7. An automatic driving vehicle that travels along a predetermined travel route, the automatic driving vehicle having
an automatic mode to automatically accelerate, decelerate and steer in accordance with an operation schedule provided through communication from an operation management center, and in which it is determined that the vehicle will arrive at a predetermined spot at predetermined time,
a semiautomatic mode to automatically steer and to accelerate and decelerate depending on occupant's manipulation in a state where a function of communicating with the operation management center in the automatic mode is limited, and
a manual mode to accelerate, decelerate and steer depending on the occupant's manipulation.

8. The automatic driving vehicle according to claim 7 including a mechanical manipulating part to be manipulated by the occupant, that steers, accelerates and decelerates in accordance with a front, rear, right or left direction of a force applied to the mechanical manipulating part by the occupant.
